(19) United States
(12) Patent Application Publication
(10) Pub. No.: US 2026/0094505 A1
(43) Pub. Date: Apr. 2, 2026

(54) SYSTEMS AND METHODS FOR CONDUCTING A GAME OF CHANCE

(71) Applicant: Samy Hanna, Las Vegas, NV (US)

(72) Inventor: Samy Hanna, Las Vegas, NV (US)

(21) Appl. No.: 19/202,898

(22) Filed: May 8, 2025

Related U.S. Application Data
(60) Provisional application No. 63/732,230, filed on Jul. 26, 2024.

(51) Int. Cl. G07F 17/32

(52) U.S. Cl. CPC G07F 17/3293; G07F 17/3211

(57) ABSTRACT

A system and method for operating a game of chance. A processor running executable instructions causes a deck of virtual cards to be separated into 7 substantially equal stacks and places a face-down stack at one of seven player locations. A player location not receiving a player bet, becomes the dealer/banker hand. During play, the dealer's bottom-most, face-down card is compared against the bottom-most, face-down card at each player location. A player wins if the player's bottom-most, face-down card exceeds the value/rank of the dealer's bottom-most, face-down card; a player loses if the player's bottom-most, face-down card ranks below the value/rank of the dealer's bottom-most, face-down card; and a push occurs when the player's bottom-most, face-down card ranks equally to the value/rank of the dealer's bottom-most, face-down card.

### CROSS-REFERENCE

This application claims priority to U.S. patent application Ser. No. 63/732,230 filed on Jul. 26, 2024 and incorporated herein for all purposes.

### FIELD OF THE INVENTION

The embodiments of the present invention relate to systems and methods for conducting a card-based game of chance in live and electronic formats.

### BACKGROUND

Casinos derive much of their gaming revenue from card-based table games and electronic gaming machines (“EGMs”) such as slot machines. Certain games perform well, and others perform poorly. Games that perform well tend to be easy and fast to play and deal. Players and dealers like easy-to-play and easy-to-deal games while operators like fast games to maximize hands or deals per hour.

Easy-to-play games are also beneficial to operators as they tend to attract new mostly young players. Thus, such games expose new players to casino games and ideally excite the new players encouraging them to try other casino games.

Accordingly, the new system and method detailed herein involve an easy-to-play and easy-to-deal card-based casino game playable in live or electronic formats.

### SUMMARY

The embodiments of the present invention relate to systems and methods for conducting a card-based game. In one system embodiment designed for 6 players, a processor running executable instructions causes a deck of virtual cards to be separated into 7 substantially equal stacks and places a face-down stack at one of seven player locations. A player location not receiving a player bet, becomes the dealer hand. During play, the dealer's bottom-most, face-down card is compared against the bottom-most, face-down card at each player location. A player wins if the player's bottom-most, face-down card exceeds the value of the dealer's bottom-most, face-down card; a player loses if the player's bottom-most, face-down card ranks below the value of the dealer's bottom-most, face-down card; and a push occurs when the player's bottom-most, face-down card ranks equally to the value of the dealer's bottom-most, face-down card. In one embodiment, cards having a rank of Ace are deemed the highest card in the deck.

In another system embodiment designed for 6 players, a live dealer causes a deck of cards to be separated into 7 substantially equal stacks and places a face-down stack at one of seven player locations depicted on the gaming table. A player location not receiving a player bet, becomes the dealer hand. During play, the dealer's bottom-most, face-down card is compared against the bottom-most, face-down card at each player location. A player wins if the player's bottom-most, face-down card exceeds the value of the dealer's bottom-most, face-down card; a player loses if the player's bottom-most, face-down card ranks below the value of the dealer's bottom-most, face-down card; and a push occurs when the player's bottom-most, face-down card ranks equally to the value of the dealer's bottom-most, face-down card. In one embodiment, cards having a rank of Ace are deemed the highest card in the deck.

In one embodiment, if a player wins, the payout is even money (e.g., 1 to 1); if the player loses, the player loses the bet; and tie is deemed a push whereby the player retains the bet. In one embodiment, side bets may allow players to bet on: (i) tie hands (i.e., a push) and/or (ii) a player hand winning by a pre-established margin greater than 1 (e.g., 2 or more) and/or (iii) a player hand winning within a pre-established margin (e.g., 2-3; 4-5; and 6 or more).

Other variations, embodiments and features of the present invention will become evident from the following detailed description, drawings and claims.

### BRIEF DESCRIPTION OF THE DRAWINGS

FIG. 1 illustrates a block diagram of an electronic gaming machine and components of the type that may be used to facilitate the embodiments of the present invention;

FIG. 2 illustrates a block diagram of an electronic gaming machine system of the type that may be used to facilitate the embodiments of the present invention;

FIG. 3 illustrates a block diagram of a wireless network system of the type that may be used to facilitate the embodiments of the present invention;

FIGS. 4A through 4E illustrate a hand dealt and played according to the embodiments of the present invention;

FIG. 5 illustrates an alternative game layout according to the embodiments of the present invention;

FIG. 6 illustrates a flow chart detailing play of an exemplary game on a live gaming table according to the embodiments of the present invention; and

FIG. 7 illustrates a flow chart detailing play of an exemplary game played online according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements, which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wired, wireless, wireline, optical fiber cable, RF, Bluetooth and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming machine” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

Those skilled in the art will recognize that certain types of EGMs, generally utilized in regulated casino environments, are still commonly referred to as “slot machines”. Although the etymology of the term “slot machine” was originally derived from a coin slot in the gaming machines at the time, coin slots have long since generally been replaced by payment input devices or bill validators which only accept paper currency or ticket-in-ticket-out vouchers and/or electronic fund transfer means, such as card readers, mobile device payment means or account interfaces. As a result, the term EGM and slot machine are used interchangeably and are defined to mean something different than a laptop or desktop computer, cell phones, tablet computer gaming devices and the like.

In addition to gaming tables, the embodiments of the present invention may be facilitated by an electronic gaming device allowing multiple players to play against one another under the control of a central server as described herein. Besides mobile devices, the electronic gaming device may be a standalone device and bar-top device forming part of a gaming device network or not.

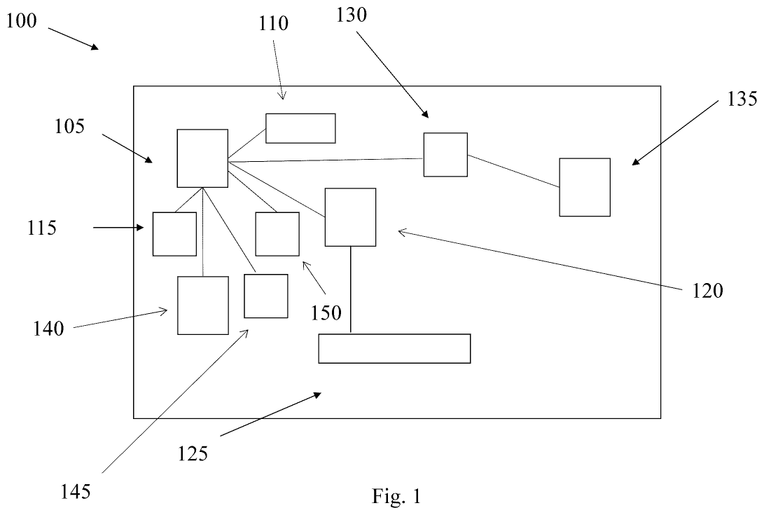

A block diagram of the electronic gaming device 100 is shown in FIG. 1. The exemplary electronic gaming device 100 may include a central processing unit (CPU) also deemed a processor 105 which controls the electronic gaming device 100 based on executable instructions stored in program read-only memory (ROM) 110 and pay table ROM 115. Program ROM 110 stores executable instructions related to the operation of the gaming device 100 and which are generally permanent. CPU 105 may be connected to a video controller 120 which provides output to one or more video displays 125. Similarly, an audio controller 130 provides audio output as dictated by the CPU 105 through speakers 135. The components, and others, may be attached to a circuit board forming a motherboard. In another embodiment, the electronic gaming device 100 may be linked to a central game server which allows players to select from games via the electronic gaming device 100. In such an embodiment, one or more processors integrated into the central server control the gaming device 100 based on instructions stored in program ROM 110.

A user interface 140 may respond to buttons on button panel or display incorporating touch screen technology or any other devices providing means for users to communicate with, and instruct, the electronic gaming device 100. Wager memory 145 stores an amount of money/credits deposited into the electronic gaming device 100 by a player and specific wager information related to each play of the electronic gaming device 100. Payout system 150 includes a coupon printer or similar device for receiving money/coupon from the electronic gaming device 100.

Funding the electronic gaming device 100 may be accomplished using currency, gaming tickets and fund transfers using mobile devices (e.g., smart phones). Bill validators may be used to accept and verify the currency and gaming tickets.

Those skilled in the art will recognize that the configuration and features of the electronic gaming device 100 disclosed herein are exemplary and may be altered in any number of ways without impacting the embodiments of the present invention.

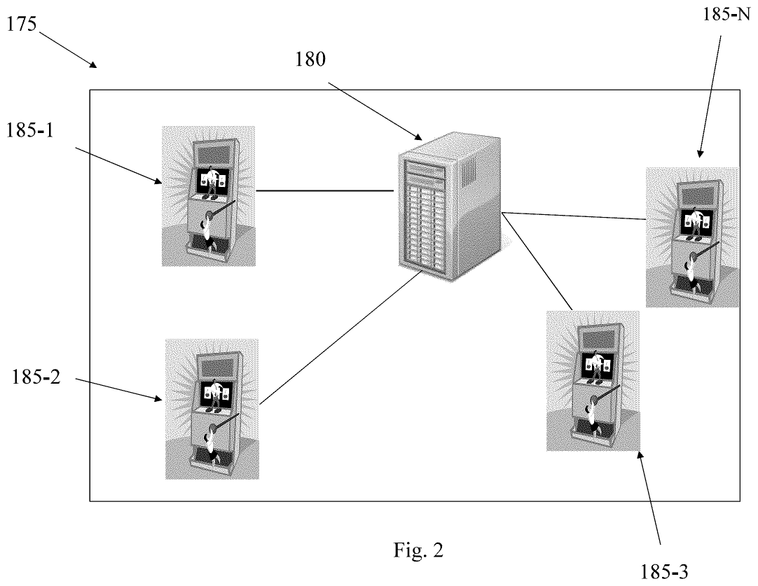

FIG. 2 shows a block diagram of a wired system 175 which may be used to facilitate play of the game according to the embodiments of the present invention. The wired system 175 comprises a central computer 180 running a casino management system or the like and including one or more processors and memory. Standalone gaming devices 185-1 through 185-N (e.g., video machines) configured to facilitate game play.

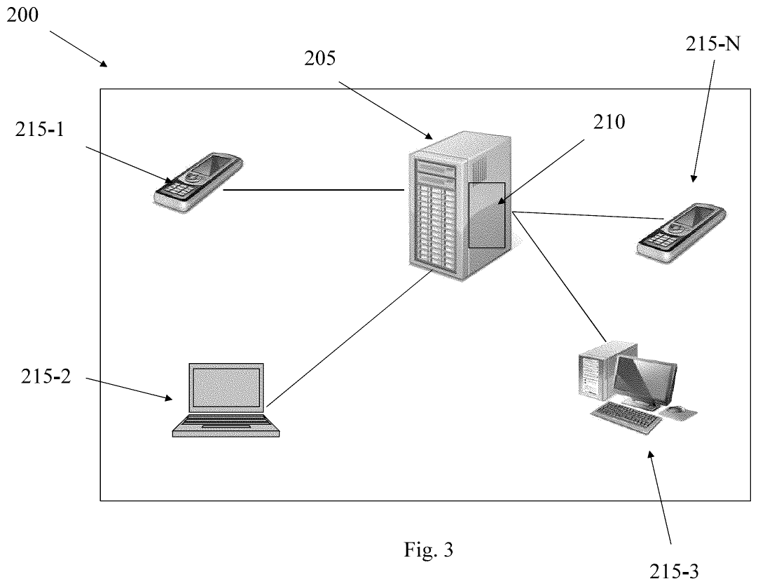

FIG. 3 shows a block diagram of a wireless system 200 which may be used to facilitate remote play of the game according to the embodiments of the present invention. The wireless system 200 comprises a game server 205, including one or more processors 210 running game software, and remote devices 215-1 through 215-N (e.g., smart phones) configured to access said game server 205 facilitating game play on the remote devices 215-1 through 215-N. In another embodiment, the digital game according to the embodiments of the present invention may be in the form of a software application (“App”) downloadable onto smart phones, tablets or computers and playable via processing power and a user interface associated therewith. Wired connections may be used as well.

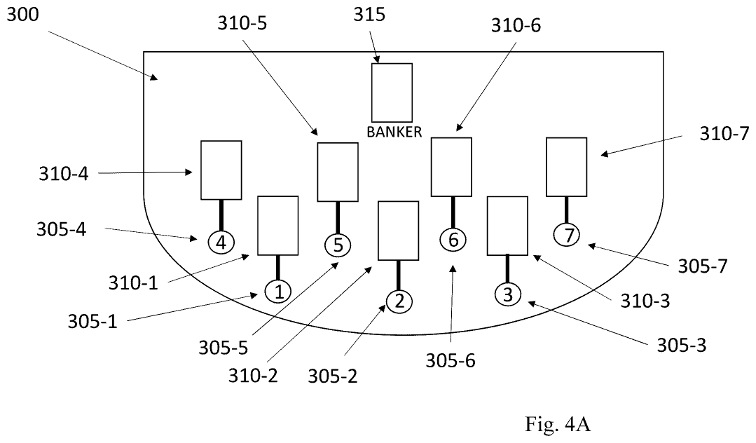

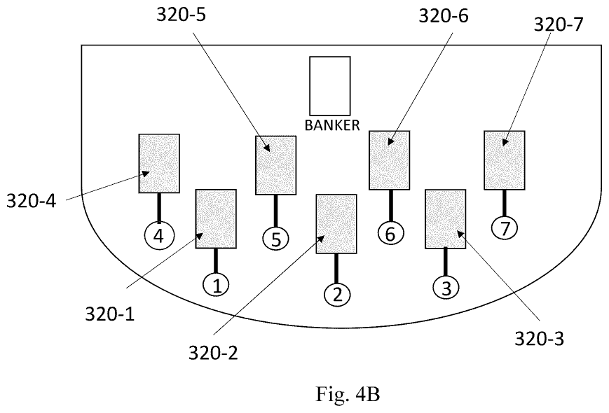

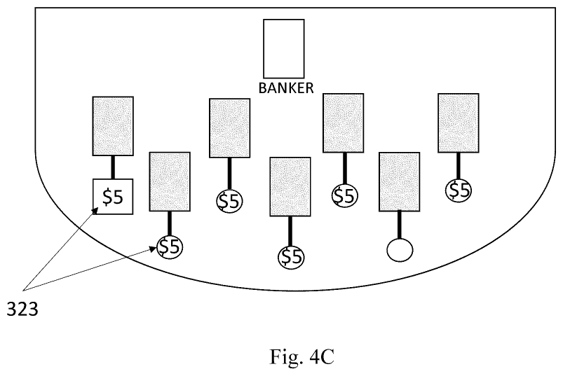

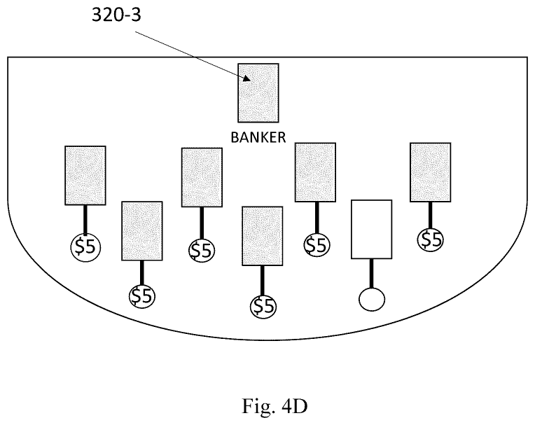

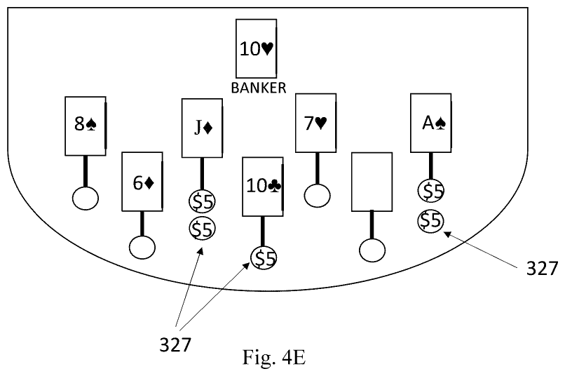

FIGS. 4A through 4E show a game layout 300 and one embodiment of play. As shown, the game layout 300 depicts seven numbered wager positions 305-1 through 305-7, seven corresponding card placement areas 310-1 through 310-7 and a banker card placement area 315. FIG. 4B shows that the card placement areas 310-1 through 310-7 have each received a stack of cards. In one embodiment, after a standard deck of 52 cards is shuffled, the dealer separates the deck into random stacks 320-1 through 320-7 and places a stack in each card placement area 310-1 through 310-7 such that the entire deck of cards is distributed.

Now referring to FIG. 4C, six players place wagers 323 by placing gaming chips on all but one of the seven wager positions 305-1 through 305-7. The operator sets the table limits of each game in play (e.g. $5-$20). As shown in FIG. 4D, once the bets have been placed on all but one of the seven wager positions 305-1 through 305-7, the stack of cards 320-3 without a bet placed in the corresponding wager position 305-3 are moved to the banker card placement area 315 to serve as the banker hand.

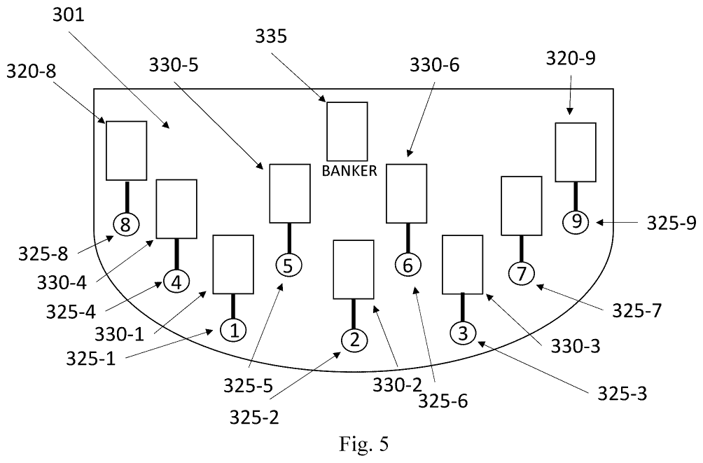

FIG. 4E shows all card stacks 320-1 through 320-7 being turned face up so that the bets may be resolved. Bets are resolved by comparing the banker's top-most face up card (e.g., the bottom-most card on the banker's stack when the banker's stack of cards was face down) to the subject player's top-most face up card (e.g., the bottom-most card on the player's stack when the player's stack of cards was face down). If the player's card outranks the banker's card, the plater wins the bet; if the banker's card outranks the player's card, the player loses the bet; and if the player's card and banker's card have the same rank, the bet is deemed a push, and the player retains the bet. As shown, in FIG. 5E, wager positions 305-5 and 305-7 are paid 327 as winning hands; wager position 305-2 is a push with the player retaining the bet; and wager positions 305-1, 305-4, 305-6 are loses with the bet being collected. In one embodiment, winning bets are paid even money. To manipulate the house edge, in other embodiments, the winning bets or push bets may pay a commission.

In other embodiments, side bets may be incorporated allowing players to bet on: (i) tie hands (i.e., a push) and/or (ii) a player hand winning by a pre-established margin greater than 1 (e.g., 2 or more) and/or (iii) a player hand winning within a pre-established margin (e.g., 2-3; 4-5; and 6 or more). Another optional side bet relates to the strength of a poker hand formed by the six player cards.

While a six player embodiments is shown in FIGS. 4A through 4E, other embodiments may accommodate other numbers of players. For example, as shown in FIG. 5, an eight player embodiment with a layout 301 depicting nine numbered wager positions 325-1 through 325-9, nine corresponding card placement areas 330-1 through 330-9 and a banker card placement area 335. In this embodiment, eight player bets are placed with the stack of cards having no bet being moved to the banker card placement area 335 where the game continues as described above. In this embodiment, two decks of cards and/or two bankers may be used. Conceivably, approximately twelve players may be accommodated on a Blackjack-style gaming table.

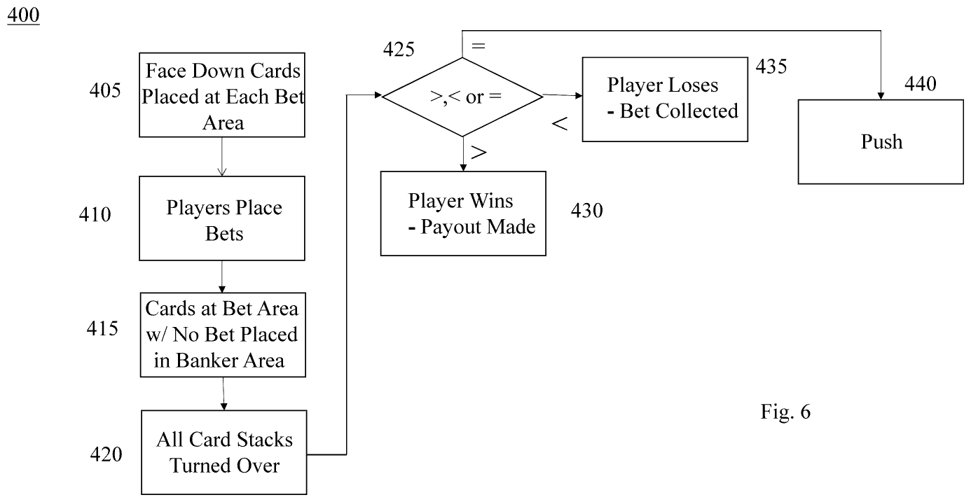

FIG. 6 shows a flow chart 400 detailing one methodology of playing a live table game according to the embodiments of the present invention. In one embodiment of the present invention, the number of players placing a bet is one less than the number of card placement areas and corresponding wager positions. At 405, a banker/dealer separates a standard shuffled deck of cards into seven random stacks and places one stack of face-down cards at each card placement area on a gaming table. At 410, players make bets by placing gaming chips on wager positions associated with each card placement area. At 415, the face-down stack of cards at the one card placement area with no bet is moved to the banker card placement area. At 420, the banker/dealer turns over all stacks of cards in the players'card placement areas and banker's card placement area. At 425, a comparison of each player's card to the banker's card to determine whether the subject player's card has a greater, lesser or equal rank compared to the banker's card. If, at 425, the subject player's card outranks the banker's card, at 430, the player wins and receives the payout. If, at 425, the banker's card outranks the subject player's card, at 435, the player losses and the player's bet is collected. If, at 425, the subject player's card has the same rank as the banker's card, at 440, the hand is a push whereby the player retains the bet.

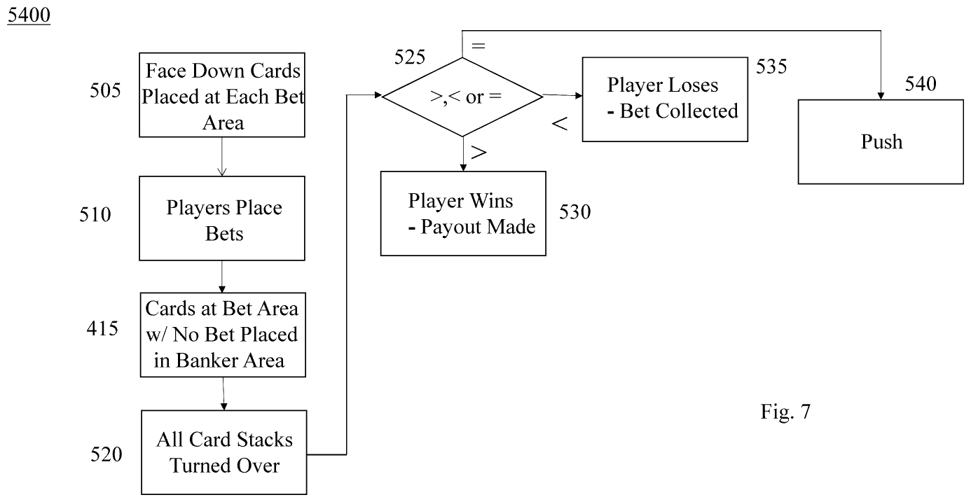

FIG. 7 shows a flow chart 500 detailing play of an exemplary game played online according to the embodiments of the present invention. At 505, a processor separates a standard shuffled, virtual deck of cards into seven random stacks and displays one stack of face-down cards at each virtual card placement area on a virtual gaming table. At 510, players make bets via a user interface on a device through which the game is being accessed. For example, a player may make a bet using a touchscreen on a mobile device or a keyboard on a laptop computer. At 515, the stack of face-down cards displayed at the one virtual card placement area with no bet is translated on the display to the virtual banker card placement area. At 520, the processor virtually turns over all stacks of cards in the players'card placement areas and virtual banker's card placement area. At 525, the processor compares each player's virtual card to the virtual banker's card to determine whether the subject player's virtual card has a greater, lesser or equal rank compared to the virtual banker's card. If, at 525, the subject player's virtual card outranks the virtual banker's card, at 530, the player wins and receives the payout paid to a credit meter. If, at 525, the virtual banker's card outranks the subject player's virtual card, at 535, the player losses and the player's bet is collected by the processor. If, at 525, the subject player's virtual card has the same rank as the virtual banker's card, at 540, the hand is a push whereby the player retains the bet.

While the detailed disclosure above focuses on removed prize blocks being replaced immediately upon being removed, in another embodiment, the arrangement of prize blocks is static. In this embodiment, once all prize blocks are destroyed and removed, a completely new arrangement of prize blocks is mapped on the secondary game display. In this manner, the player must destroy all prize blocks before a new arrangement of prize blocks is presented to the player. In this embodiment, the destruction of all prize blocks may trigger an additional award to the player.

Although the invention has been described in detail with reference to several embodiments, additional variations and modifications exist within the scope and spirit of the invention as described and defined in the following claims.

I claim:

1. A gaming system comprising:
a monetary input device configured to receive a physical item associated with a monetary value;
a user interface configured to:
enable a player to select a wager for a game of chance and enable the player to initiate a cash out operation;
at least one processor running executable instructions related to a game of chance;
said at least one processor programmed to:
add said monetary value to a credit balance for said player;
deduct said selected wager from said credit balance; and
decrease said credit balance in response to said cash out operation;
one or more displays;
memory in communication with said at least one processor; and
wherein said at least one processor runs said executable instructions to: (i) display a plurality of virtual stacks of cards from a virtual deck of cards in a plurality of virtual player card placement areas; (ii) accept wagers via said user interface on all but one of said virtual player card placement areas; (iii) translate a virtual stack of cards from a virtual card placement area having received no wager to a virtual banker's card placement area; (iv) reveal a bottom-most virtual card from each said virtual stack of cards; (v) compare said bottom-most virtual card from each said virtual stack of cards at each said virtual player card placement area to said bottom-most virtual card at said virtual banker's card placement area; and (vi) resolve wagers based on ranks of each said bottom-most virtual card from each said virtual player stack of cards at each said virtual player card placement areas to said bottom-most virtual card at said virtual banker's card placement area.

2. The gaming system of claim 1 further comprising seven virtual player card placement areas.

3. The gaming system of claim 1 wherein said deck of cards comprises 52 cards.

4. The gaming system of claim 1 further comprising twelve virtual player card placement areas.

5. The gaming system of claim 4 wherein two decks of cards are used.

6. The gaming system of claim 1 further comprising one or more side bets.

7. A gaming system comprising:
a user interface configured to accept a player wager for a game of chance;
at least one processor running executable instructions related to a game of chance;
memory in communication with said at least one processor; and
wherein said at least one processor runs said executable instructions to: (i) display a plurality of virtual stacks of cards from a virtual deck of cards in a plurality of virtual player card placement areas; (ii) accept bets via said user interface on all but one of said virtual player card placement areas; (iii) translate a virtual stack of cards from a virtual card placement area having received no bet to a virtual banker's card placement area; (iv) reveal a bottom-most virtual card from each said virtual stack of cards; (v) compare said bottom-most virtual card from each said virtual stack of cards at each said virtual player card placement area to said bottom-most virtual card at said virtual banker's card placement area; and (vi) resolve bets based on ranks of each said bottom-most virtual card from each said virtual player stack of cards at each said virtual player card placement area to said bottom-most virtual card at said virtual banker's card placement area.

8. The gaming system of claim 7 further comprising seven virtual player card placement areas.

9. The gaming system of claim 7 wherein said deck of cards comprises 52 cards.

10. The gaming system of claim 7 further comprising twelve virtual player card placement areas.

11. The gaming system of claim 10 wherein two decks of cards are used.

12. The gaming system of claim 7 further comprising one or more side bets.

13. A gaming system comprising:
a gaming table layout supported by a gaming table, said gaming table layout depicting a plurality of player card placement areas and a banker card placement area, and a wager placement area corresponding to each player card placement area;
a standard deck of cards;
an automatic card shuffling machine; and
a dealer instructed to:
(i) deal a plurality of stacks of cards from a deck of cards in said plurality of player card placement areas; (ii) accept wagers on all but one of said player card placement areas; (iii) move a stack of cards from a card placement area having received no wager to said banker's card placement area; (iv) reveal a bottom-most card from each said stack of cards; (v) compare said bottom-most card from each said stack of cards at each said player card placement area to said bottom-most card at said banker's card placement area; and (vi) resolve wagers based on ranks of each said bottom-most card from each said player stack of cards at each said player card placement area to said bottom-most card at said banker's card placement area.

14. The gaming system of claim 13 further comprising seven virtual player card placement areas.

15. The gaming system of claim 13 wherein said deck of cards comprises 52 cards.

16. The gaming system of claim 13 further comprising twelve virtual player card placement areas.

17. The gaming system of claim 16 wherein two decks of cards are used.

18. The gaming system of claim 13 wherein said gaming table layout further depicts one or more side bets.
